(19) United States
(12) Patent Application Publication
(10) Pub. No.: US 2021/0197469 A1
(43) Pub. Date: Jul. 1, 2021

(54) BUILD MATERIAL PROCESSING

(71) Applicant: HEWLETT-PACKARD DEVELOPMENT COMPANY, L.P., Spring, TX (US)

(72) Inventors: Alexander David LAWS, Vancouver, WA (US); Peter BOUCHER, Vancouver, WA (US); Devin KOEPL, Vancouver, WA (US); Samantha KANG, Vancouver, WA (US); Charles Hugh OPPENHEIMER, Vancouver, WA (US); Justin M ROMAN, Vancouver, WA (US)

(73) Assignee: HEWLETT-PACKARD DEVELOPMENT COMPANY, L.P., Houston, TX (US)

(21) Appl. No.: 16/076,359

(22) PCT Filed: Jul. 27, 2017
(86) PCT No.: PCT/US2017/044093

§ 371 Date: Aug. 8, 2018

(51) Int. Cl. B29C 64/314; B29C 64/393; B29C 64/357; B33Y 10/00; B33Y 30/00; B33Y 40/00; B33Y 50/02

(52) U.S. Cl. CPC B29C 64/314; B29C 64/393; B29C 64/357; B33Y 50/02; B33Y 30/00; B33Y 40/00; B33Y 10/00

(57) ABSTRACT

According to one aspect there is provided a build material processing apparatus for a 3D printing system. The system comprises a sieve to sieve build material, the sieve to receive a flow of build material, a vibrator mechanism to vibrate the sieve at a resonant frequency. A controller is provided to determine displacement characteristics of the sieve, determine, based on the displacement characteristics, a fill state of the sieve, and control a flow of build material to the sieve based on the determined fill state.

### BACKGROUND

Some three-dimensional (3D) printing, or additive manufacturing systems, use powder-type build material to generate 3D printed objects. Such 3D printing systems generally move powdered build material between different locations within the system, for example, from a storage unit to a build platform. Some 3D printers, or post-processing units used in conjunction with 3D printers, may use at least partially automated techniques to recover any non-solidified build material from a build unit in which a 3D object has been generated.

### BRIEF DESCRIPTION

Examples will now be described, by way of non-limiting example only, with reference to the accompanying drawings, in which:

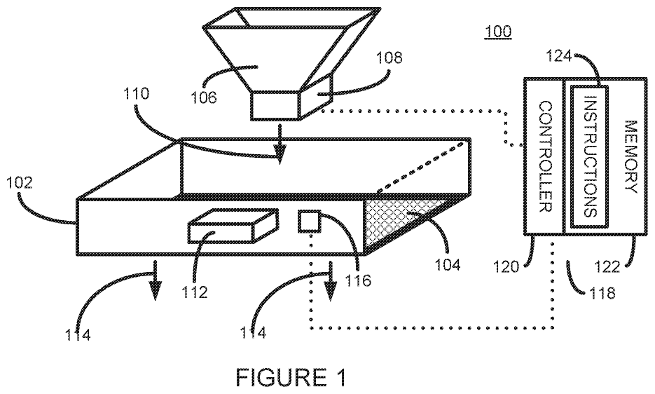

FIG. 1 is an illustration of a build material processing system according to one example;

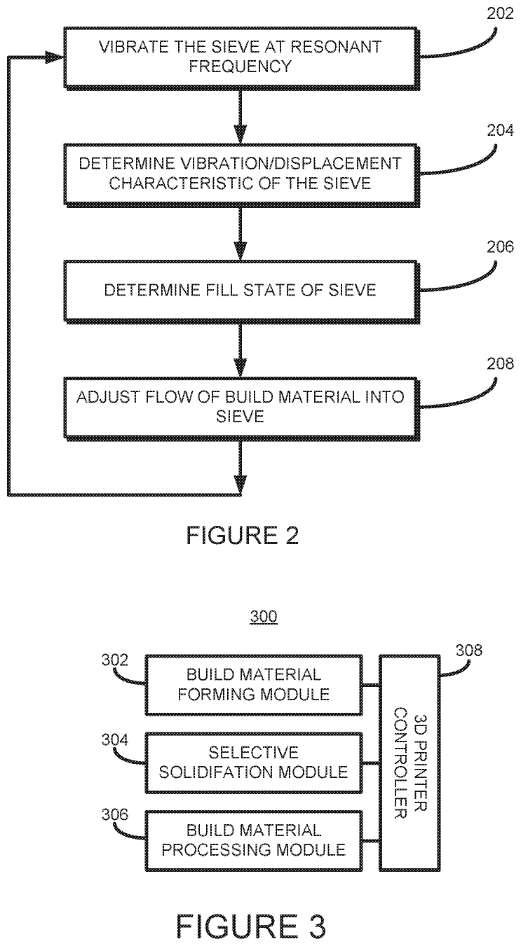

FIG. 2 is a flow diagram outlining a method to control a build material processing system according to one example; and

FIG. 3 is a block diagram of a three dimensional printing system incorporating a build material processing module according to one example.

### DETAILED DESCRIPTION

Unfused build material may be recovered from a build unit in which a 3D object has been generated using various techniques, such as flowing air through the build unit, vacuuming build material out of the build unit, and vibrating the build unit. Such techniques may, in some cases, be used individually or in combination.

Recovered build material may need to be processed before it can be reused in the generation of further 3D objects. Processing may include, for example, sieving to remove any semi-fused or conglomerated portions of the recovered build material.

Referring now to FIG. 1 there is shown a build material processing system 100 according to one example. In one example the build material processing system 100 may be integrated into a 3D printing system. In another example the build material processing system 100 may be part of a separate 3D printing build material management system.

The system 100 comprises a screen box, or sieve, 102. In the example shown the sieve 102 forms a generally open-topped container, the base of which is at least partially formed of a sieve element 104. In other examples, the sieve 102 may be substantially closed at the top. In FIG. 1 the right-hand side end panel of the sieve 102 is not shown to allow the sieve element 104 to be visible. The sieve element 104 may be formed, for example, of a mesh, of an apertured plate, or of any other suitable sieving mechanism. The sieve element 104 may, for example, comprise apertures of a single size, or apertures of a range of different sizes. The size, or sizes, of the apertures may be chosen based on the characteristics of the build material which is to be processed by the build material processing system 100. For example, the size of the apertures maybe chosen to allow only build material having a predetermined maximum particle size to pass through the sieve element 104. In this way, any conglomerated build materials or any other contaminants having a size larger than the biggest apertures will be either broken down by the sieve element 104 such that they pass through the sieve element 104, or they will be stopped from passing through the sieve element 104.

Build material may be loaded into the sieve 102 from a hopper 106 or through any other suitable build material conveyancing system, such as a tube or other conduit. The flow of build material from the hopper 106 is controlled by a flow regulator 108. The flow regulator 108 may be any suitable valve which may provide an open and a closed position. In some examples the valve allows a restricted flow between the open and closed position, or indeed may allow a wide range of different build material flows. Build material flows through the flow regulator 108 and into the sieve 102 as indicated by arrow 110.

In a further example, the function of the flow regulator may be performed by an upstream element, for example an element of a build material conveyancing system (not shown).

The sieve 102 further comprises a vibrator mechanism 112 which is connected to the sieve 102. The vibrator mechanism 112 is to impart small amplitude vibrations to the sieve 102 in at least one of the x, y, or z axes. The vibrations assist build material in the sieve 102 from passing through the sieve element 104 as indicated by arrows 114. In one example the sieve 102 may be mounted on springs (not shown) that allow the sieve 102 to vibrate without transferring the vibrations to other elements of the system 100.

The vibrator mechanism 112 may be driven by a control circuit (not shown) or may contain control circuitry to allow it to vibrate it at a resonant frequency. The resonant frequency of the sieve system 102 will change as the quantity of build material in the sieve, and hence the mass of the sieve system, changes. In one example the drive circuitry may monitor the frequency of vibration of the sieve at various frequencies, for example by stopping driving of the vibration mechanism 112 and determining the decaying vibration frequency of the sieve to allow the sieve system to be driven at its resonant frequency, even as the amount of build material in the sieve varies over time.

The sieve 102 additionally comprises a sensor 116. In one example the sensor 116 is attached to one of the walls of the sieve 102. The sensor 116 allows vibration, or displacement, characteristics, such as frequency, and amplitude, of the sieve 102 to be determined. In one example, the sensor 116 may comprise an accelerometer. In another example, the sensor 116 may comprise an optical linear encoder to read encoder markings on an encoder strip (not shown) located on a non-vibrating portion of the system 100.

In one example, the linear encoder may be used to enable the controller 120 to determine a pseudo-static sieve position by averaging the sieve position, or displacement, over time. For example, if the sieve is mounted on springs, the height, or vertical displacement, of the sieve 102 may change as the quantity of build material in the sieve 102 changes. The mass of the sieve system may then be derived from the determined pseudo-static position. The sieve 102 may then be driven at the resonant frequency for efficient sieving.

In one example the drive circuitry may be toggled to operate in one of at least two modes. For example, a first mode may cause the sieve 102 to vibrate at or close to its resonant frequency, and a second mode may cause the sieve 102 to be vibrated at a frequency different from its resonant frequency to allow measurement of vibration, or displacement, characteristics of the sieve 102.

In another example the sensor 116 may be integrated into the vibrator mechanism 112. This may allow, for example, a controller to determine vibration, or displacement, characteristics of the sieve by interrogating the vibrator mechanism 112.

The sensor 116 is connected to a build material flow manager 118. In the example shown the build material flow manager 118 comprises a controller 120, such as a microprocessor or microcontroller, connected via a communications bus (not shown) to a memory 122. The memory 122 stores controller readable build material flow management instructions 124 which, when executed by the controller, control the flow of build material into the sieve, as described below.

An example operation of the build material processing system 100 is described below with additional reference to the flow diagram of FIG. 2.

At block 202, the flow manager 118 controls the vibrator mechanism 112 to vibrate the sieve 102 at its resonant frequency. As described above, this may involve supplying electrical power to the vibrator mechanism 112 and allowing the vibrator mechanism 112 to automatically determine, and subsequently to vibrate the sieve 102 at, the resonant frequency of the sieve system.

At block 204, the flow manager 118 determines, through the sensor 116 one or multiple vibration, or displacement, characteristics of the sieve 102. In one example, the vibration, or displacement, characteristics may include one or more of: vibration frequency; vibration amplitude; vibration direction; and a vertical displacement of the sieve.

At block 206, the flow manager 118 determines, based on the determined vibration, or displacement, characteristics a fill state of, or an amount of build material in, the sieve 102. The fill state may be determined in a number of different manners. For example, a resonant frequency of the sieve 102 when empty may be determined through testing and the empty resonant frequency stored in the memory 122. Similarly, the resonant frequency of the sieve when full may be determined through testing and the full resonant frequency stored in the memory 122. By full is meant not necessarily completely full, but full to a predetermined maximum level. This may, for example, be chosen to prevent any build material in the sieve 102 from exiting the sieve from the top open portion when vibrated. In this manner, the determined vibration, or displacement, characteristic of the sieve allows the flow manager to determine an approximate fill state of the sieve, without having to use load sensors. This allows for a particularly economic system.

At block 208, the flow manager 118 sends control signals to the flow regulator 108 to adjust the flow of build material into the sieve. For example, when the sieve 102 is being vibrated and the determined fill state of the sieve is empty, the flow manager 118 may control the flow regulator 108 to allow build material to flow into the sieve 102. If the determined fill state is full, the flow manager 118 may control the flow regulator 108 to stop build material from flowing into the sieve 102. In one example, a proportional-integral-derivative (PID) type controller may be implemented by the instructions 124 to allow a more adaptive flow of build material into the sieve 102.

The flow manager 118 enables a simple but effective control of the flow of build material into the sieve 102 even if the flow of build material into the hopper 108 is at a non-constant rate. For example, if the flow manager 118 determines that the fill state of the sieve is empty, and that after having controlled the flow regulator 108 to allow build material to flow into the sieve determines that the fill state is still empty this may indicate that there is no more build material available to be processed by the sieve 102. In this case the flow manager 118 may control the vibrator mechanism 112 to stop vibrating, at least temporarily. This allows the flow manager 118 to adapt to the amount of build material available for processing by the sieve 102, without having any direct data on the quantity of build material to be processed.

Referring now to FIG. 3, there is shown a block diagram of a three-dimensional printing system 300 according to one example. The 3D printing system 300 comprises a build material forming module 302 to form, for example on a build platform of a build unit, successive layers of a suitable powder or granular type build material. Example powders may include PA12, PA11, ceramics, metals, thermoplastics, or the like. The build material forming module 302 may, for example, fora layer of build material on a build platform by spreading with a roller a pile of build material deposited to one side of the build platform.

The 3D printing system 300 additionally comprises a selective solidification module 304. This module acts to selectively solidify portions of each formed layer of build material to generate layers of a 3D object being generated. The selective solidification may be performed, for example, in an association with a digital model of a 3D object to be generated. In one example the selective solidification module comprises a laser sintering system. In another example the selective solidification module comprises a fusing agent and fusing lamp system in which fusing agent may be selectively printed on each formed layer of build material and a fusing lamp causes those portions of build material on which fusing agent has been applied to heat up and to melt and fuse.

The 3D printing system 300 further comprises a build material processing module 306, such as a build material processing system 100 as described herein.

A 3D printer controller 308 controls operation of each of the modules 302, 304, and 306, to form 3D objects. Once a 3D print job, or 3D printing operation, has been completed, unfused, or non-solidified, build material in a build unit may be extracted therefrom and sent to be processed by the build material processing module 306. The build material may be conveyed between modules of the 3D printing system using any suitable conveyancing system, such as pneumatic or mechanical conveyancing system. Unfused build material processed by the build material processing module may be stored in a storage container within the 3D printing system and reused during subsequent 3D print jobs to generate further 3D objects.

It will be appreciated that example described herein can be realized in the form of hardware, software or a combination of hardware and software.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A build material processing apparatus for a 3D printing system comprising:
a sieve to sieve build material, the sieve to receive a flow of build material;
a vibrator mechanism to vibrate the sieve at a resonant frequency;
a controller to:
determine displacement characteristics of the sieve;
determine, based on the displacement characteristics, a fill state of the sieve; and
control a flow of build material to the sieve based on the determined fill state.

2. The apparatus of claim 1, further comprising a sensor connected to the sieve to measure the displacement characteristics of the sieve.

3. The apparatus of claim 2, wherein the sensor is to measure at least one of: vibration frequency; vibration amplitude; vibration direction; and displacement.

4. The apparatus of claim 1, wherein the controller determines displacement characteristics of the sieve from the vibrator mechanism.

5. The apparatus of claim 1, further comprising a flow regulator through which build material is passed to the sieve, wherein the controller is to control the flow of build material through the flow regulator.

6. The apparatus of claim 1, wherein the controller is to:
open the flow controller when the determined fill state is empty and is to close the flow controller when the determined fill state is full.

7. The apparatus of claim 6, wherein the controller is to determine when the fill state remains empty after the flow controller has been opened and to stop vibration of the sieve.

8. The apparatus of claim 1, wherein the controller is to adjust the flow regulator between an open and closed position based on the determined fill state.

9. A three-dimensional printer comprising:
a build material forming module to form a layer of build material on a build platform of a build unit;
a selective solidification module to selectively solidify portions of each formed layer of build material in accordance with an object model;
a build material processing module to extract non-solidified build material from the build unit after completion of a printing operation;
a sieve to receive a flow of build material from the build material processing module;
a vibrator to vibrate the sieve at a resonant frequency;
a controller to:
determine a vibration characteristics of the sieve;
determine; based on the vibration characteristics, a fill state of the sieve; and
control the flow of build material to the sieve based on the determined fill state.

10. The three-dimensional printer of claim 9, further comprising a sensor attached to the sieve to measure at least vibration frequency, a vibration amplitude, and a vibration direction of the sieve.

11. The three-dimensional printer of claim 9, wherein the vibrator is to automatically determine the resonant frequency of the sieve.

12. The three-dimensional printer of claim 9, further comprising drive circuitry to drive the vibrator at the resonant frequency of the sieve.

13. The three-dimensional printer of claim 10, further comprising a storage container to store build material processed by the sieve for use in subsequent 3D printing operations.

14. A method of controlling the flow of build material into a build material processor, comprising:
vibrating a sieve at a resonant frequency;
determining displacement characteristics of the sieve;
determining from the displacement characteristics an amount of build material in the sieve;
controlling the flow of build material into the sieve based on the determined amount of build material in the sieve.

15. The method of claim 14, further comprising determining when the sieve remains empty, and stopping the vibration of the sieve.
